(19) United States
(12) Patent Application Publication
(10) Pub. No.: US 2015/0290632 A1
(43) Pub. Date: Oct. 15, 2015

(54) IRON AND COPPER-CONTAINING CHABAZITE ZEOLITE CATALYST FOR USE IN NOx REDUCTION

(71) Applicant: Ford Global Technologies, LLC, Dearborn, MI (US)

(72) Inventors: Christine Kay Lambert, Dearborn, MI (US); Clifford Norman Montreuil, Livonia, MI (US)

(73) Assignee: Ford Global Technologies, LLC, Dearborn, MI (US)

(21) Appl. No.: 14/248,860

(22) Filed: Apr. 9, 2014

(51) Int. Cl. B01J 29/88; B01D 53/94

(52) U.S. Cl. CPC B01J 29/88; B01D 53/9418; B01D 2255/50; B01D 2255/20761; B01D 2255/102

(57) ABSTRACT

A chabazite (CHA) zeolite catalyst containing iron and copper is provided as an SCR catalyst for reducing nitrogen oxides (NOₓ) from vehicle engine exhausts. The catalyst is formed by incorporating iron during synthesis of the chabazite zeolite, followed by incorporating copper in an ion-exchange step. The resulting catalyst reduces nitrogen oxides over a wide range of temperatures from about 200° C. to about 700° C.

### BACKGROUND OF THE INVENTION

Embodiments described herein relate to the preparation and use of a chabazite (CHA) zeolite catalyst in reducing nitrogen oxides (NOₓ) from vehicle exhausts, and more particularly, to the preparation and use of a chabazite (CHA) zeolite catalyst containing iron and copper therein which can be used as a single SCR catalyst in an exhaust system for the reduction of nitrogen oxides over a wide temperature range.

Catalysts have been used in an attempt to reduce emissions of nitrogen oxides (NOₓ) from vehicle engine exhausts. A number of catalysts are currently used to convert these exhaust components to environmentally acceptable compounds. Selective catalytic reduction catalysts (SCR) are used to convert NOₓ to N₂ and typically comprise metal-promoted zeolites and utilize an ammonia reductant, typically produced by the thermal breakdown of aqueous urea, which is injected into the exhaust stream. Ideally, the SCR catalysts should be able to retain good catalytic activity over a wide range of temperature conditions typically encountered in vehicle exhaust systems, for example, from about 200° C. to 600° C. or higher.

There are generally two types of catalysts which are typically used in the art for selective catalytic reduction of NOₓ from gasoline or diesel engine exhaust. One type is based on copper zeolite catalysts having a chabazite (CHA) framework, i.e., copper chabazite zeolite catalysts. Chabazite (CHA) is a tectosilicate mineral having the general formula X_{(n/m)}AlₙSi₍₃₆₋ₙ₎O₇₂(H₂O)₄₀, where X is generally Ca, K, or Na, but can be replaced by various metal cations, and where m is the valence of the balancing cation. However, we have found that such catalysts tend to lose activity at higher temperatures, i.e., greater than 550° C., and may actually increase NOₓ production by the oxidation of ammonia. A second type of SCR catalyst is based on zeolite catalysts which contain ion-exchanged iron such as iron-exchanged beta zeolite (BEA). Such catalysts provide good NOₓ reduction at high temperatures but suffer from other disadvantages. For example, beta zeolites have insufficient thermal stability for prolonged use at high temperatures and tend to adsorb large amounts of hydrocarbons, which can result in exothermic reactions which can damage the catalyst.

While it would be desirable to incorporate metals such as iron into chabazite zeolites to achieve both high activity and improved thermal stability, attempts to do so have met with little success. For example, it is difficult to incorporate iron into chabazite zeolites having high temperature stability such as SSZ-13 using traditional ion-exchange methods due to the small pore openings of the chabazite structure. For example, an SSZ-13 CHA has a pore size of about 3.5 to 4.0 Angstroms.

In commonly-assigned application Ser. No. 14/183,969, incorporated herein by reference, an iron-zeolite chabazite (CHA) catalyst is described and is used to reduce nitrogen oxides in vehicle engine exhausts. The catalyst exhibits good high temperature NOx conversion activity and stability at temperatures greater than about 500° C. However, in order to provide activity at lower temperatures, an additional catalyst such as a conventional copper chabazite zeolite catalyst must be positioned downstream from the iron-zeolite chabazite catalyst.

Accordingly, we have identified a need for a single metal-based SCR catalyst which achieves both low and high temperature NOₓ conversion activity while saving space and avoiding the costs of providing a second catalyst in an exhaust gas treatment system.

### SUMMARY OF THE INVENTION

Embodiments of the invention meet those needs by providing a single chabazite (CHA) zeolite catalyst containing both iron and copper which reduces nitrogen oxides in vehicle engine exhausts. The catalyst exhibits good NOₓ conversion activity at temperatures ranging from about 200° C. to 700° C. as yell as thermal stability at such temperatures. The catalyst also exhibits improved performance compared to other chabazite zeolite catalyst materials as the incorporation of iron provides good performance at high temperatures, i.e., greater than about 400° C., and the incorporation of copper provides improved performance at low temperatures, i.e., less than about 400° C.

The CHA zeolite catalyst containing iron and copper also differs from other chabazite zeolite catalyst materials because the iron is incorporated into the crystal lattice structure during synthesis of the chabazite, followed by an ion-exchange step to incorporate copper. This differs from conventional methods which incorporate iron into the CHA structure by performing an Fe ion-exchange in a post-synthesis step.

According to one aspect of the invention, a catalyst is provided comprising a zeolite having a chabazite (CHA) structure which contains iron and copper; wherein the iron has been incorporated into the zeolite during synthesis of the zeolite with no post-synthesis step (such as an ion-exchange step), and wherein copper has been incorporated into the zeolite by ion-exchange after synthesis of the zeolite.

Preferably, the CHA zeolite catalyst is formed into a slurry and washcoated onto a substrate such as a cordierite monolith or a wall-flow substrate for use as an SCR catalyst. The catalyst may be washcoated onto a substrate selected from a cordierite monolith, a cordierite wall-flow filter, a silicon carbide wall-flow filter, or a metallic monolith substrate. Preferably, the catalyst exhibits NOₓ reduction activity at a temperature ranging from about 200° C. to about 700° C.

Iron is present in the chabazite zeolite in an amount of from about 0.25% to about 4.0% by weight, and more preferably, from about 0.5% to about 1.25%, based on the total weight of chabazite.

The copper is present in the chabazite zeolite in an amount of from about 2.5 to about 6.6% by weight, and more preferably, from about 3% to about 5.5% based on the total weight of chabazite.

The chabazite zeolite preferably comprises SSZ-13, and has a pore size of about 3 to 5 Angstroms, and more preferably, about 3.8 Angstroms. The chabazite zeolite has a silica to alumina ratio of about 7 to about 15.

The chabazite zeolite preferably has a surface area of at least about 400 m²/g, and preferably, from about 400 to about 600 m²/g.

According to another embodiment of the invention, a method is provided for making a chabazite zeolite catalyst containing iron and copper. The method comprises preparing an aqueous mixture containing a silica source and a strong base such as sodium hydroxide; adding a NH₄—Y zeolite and a source of ferric ions such as ferric nitrate to the mixture, adding an organic templating agent to the mixture, and heating and calcining the mixture to form a chabazite zeolite containing iron in the lattice structure thereof. The method further includes performing an ammonium-ion exchange of the zeolite and then performing a copper-ion exchange to incorporate copper in the catalyst. In one embodiment, the templating agent comprises N,N,N-trimethyl-1-adamantanamine iodide.

In one embodiment, the source of ferric ions is included in the mixture in an amount of about 5 to 100% by weight, and more preferably, about 5 to about 20% by weight based on the weight of the NH₄—Y zeolite used in the synthesis.

According to another aspect of the invention, a method for treating engine exhaust gases is provided which comprises providing an SCR catalyst in an exhaust passage of an engine, wherein the SCR catalyst comprises a chabazite zeolite catalyst containing iron and copper; wherein the iron has been incorporated into the zeolite during synthesis of the zeolite with no post-synthesis step, and wherein copper has been incorporated into the zeolite by ion-exchange after synthesis of the zeolite. The method includes exposing the catalyst to engine exhaust gas emissions containing NOₓ such that at least a portion of the emissions are reduced, preferably to N₂, at a temperature between about 200° C. to about 700° C.

An exhaust treatment system is also provided which comprises a diesel oxidation catalyst and an SCR catalyst positioned downstream from the diesel oxidation catalyst, where the SCR catalyst comprises a chabazite zeolite catalyst containing iron and copper; where the iron has been incorporated into the zeolite during synthesis of the zeolite with no post-synthesis step, and the copper has been incorporated into the zeolite by ion-exchange after synthesis of the zeolite.

In one embodiment, the exhaust treatment system further includes a diesel particulate filter positioned downstream from the SCR catalyst; wherein the filter includes a coating of the chabazite zeolite catalyst thereon.

Accordingly, it is a feature of embodiments of the invention to provide a CHA zeolite catalyst containing both iron and copper therein which reduces nitrogen oxides from a vehicle exhaust, which provides good activity at both high and low temperatures, and which is thermally stable over the entire range of temperatures encountered in vehicle exhaust systems.

Other features and advantages of the invention will be apparent from the following description, the accompanying drawings, and the appended claims.

### BRIEF DESCRIPTION OF THE DRAWINGS

FIG. 1 is a schematic illustration of an exhaust treatment system including the chabazite (CHA) zeolite SCR catalyst containing iron and copper in accordance with an embodiment of the invention;

FIG. 2 is a schematic illustration of an exhaust stream system including a (CHA) zeolite SCR catalyst on a diesel particulate filter in accordance with another embodiment of the invention;

FIG. 3 is a graph of NOₓ conversion versus temperature for a degreened copper and iron containing chabazite zeolite catalyst prepared in accordance with an embodiment of the invention and a comparative copper CHA SCR catalyst; and

FIG. 4 is a graph of the effect of aging (80 hrs at 800° C.) on NCₓ conversion versus temperature for a copper and iron containing chabazite zeolite catalyst prepared in accordance with an embodiment of the present invention and a comparative copper CHA SCR catalyst.

### DETAILED DESCRIPTION OF THE PREFERRED EMBODIMENTS

The use of a single chabazite (CHA) zeolite catalyst containing both iron and copper for reducing vehicle exhaust emissions provides an advantage over other SCR catalysts such as copper chabazite zeolite catalysts and iron-exchanged beta-zeolite catalysts as it provides NOₓ reduction activity over a wider temperature range, it is thermally stable, and it does not exhibit any significant hydrocarbon adsorption because of the relatively small pore size of the chabazite. The iron provides NOₓ reduction activity at higher temperatures, i.e., ranging from about 400° C. to about 700° C., while the copper provides NOₓ reduction activity at lower temperatures ranging from about 200° C. to about 400° C.

In addition, incorporating iron during synthesis of the chabazite zeolite eliminates the need to attempt a post-synthesis step such as an ion-exchange step to add iron. A conventional ion-exchange method results in the incorporation of the introduced cation inside the lattice structure of a zeolite, replacing cations at the Bronsted (proton donor) sites. Attempts to incorporate iron using an ion-exchange method is not feasible due to the small pore size of chabazites. By “small pore size,” it is meant that the chabazite pore is comprised of an eight-membered oxygen ring having a maximum diameter of about 0.45 nm. In addition to SSZ-13, other chabazite zeolites having small pore sizes include ZK-5, SAPO-34, and ferrierite (FER).

By adding iron during synthesis of the chabazite, the iron becomes incorporated into or entrapped within the crystal lattice of the chabazite (SSZ-13) structure. The presence of iron in the chabazite provides NOₓ reduction at higher temperatures, i.e., temperatures of about 400° C. and higher.

We have additionally discovered that by performing an ammonium ion exchange on the as-synthesized iron-containing chabazite zeolite catalyst, followed by a copper ion exchange step, copper is effectively incorporated into the catalyst such that the catalyst provides NOₓ reduction at low temperatures, i.e., temperatures between about 200° C. to about 400° C. The use of a single catalyst which performs both at high and low temperatures saves space in an exhaust system and is less costly than providing two separate catalysts.

Unless otherwise indicated, the disclosure of any ranges in the specification and claims are to be understood as including the range itself and also anything subsumed therein, as well as endpoints.

The zeolites used in embodiments of the invention have a chabazite (CHA) crystal structure as determined by X-ray diffraction analysis. The type of CHA zeolite used in the catalyst is preferably SSZ-13 CHA and has a Si/Al ratio of between about 7 to 15, and preferably, about 9 to 12. This zeolite is synthetically prepared by a process which includes mixing about 70 to 85 wt % of a silica source and about 0.5 to 5.0 wt % sodium hydroxide; adding about 5 to 10 wt % of a NH₄—Y zeolite and about 5 to 20 wt % ferric nitrate to the mixture, and adding about 10 to 15 wt % of an organic templating agent to the mixture. The silica source may comprise a sodium silicate solution (waterglass). The templating agent preferably comprises N,N,N-trimethyl-1-adamantanamine iodide. The mixture is heated in a sealed autoclave at a temperature of about 140° C. for about 6 days. The resulting CHA product may then be filtered, washed with water, and dried.

The product is then calcined at a temperature of about 600° C. for about 24 hours. The calcination achieves burnoff of the organic templating agent and may help strengthen the CHA crystal structure. The process for synthesizing the zeolite is similar to the SSZ-13 zeolite synthesis described in Fickel et al., “Copper Coordination in Cu-SSZ-13 and Cu-SSZ-16 Investigated by Variable-Temperature XRD, J. Phys. Chem. C 2010, 114, 1633-1640, incorporated herein by reference. However, we have discovered that by adding iron to the mixture during synthesis in small amounts, the iron either becomes incorporated into or entrapped within the crystal lattice of the resulting SSZ-13 structure.

Because the as-synthesized iron-containing SSZ-13 product has a high sodium content, it is preferable to exchange the sodium to ammonium form by an ammonium ion exchange step in which an ammonium salt such as ammonium nitrate is added to the synthesized iron-zeolite chabazite as a solution, filtered, washed and dried. For example, about 250 cc of a 0.5 M NH₄NO₃ solution is heated to about 65-75° C. and about 15 g of the iron-zeolite chabazite is added to the solution. The pH is adjusted with dilute nitric acid or ammonium hydroxide to maintain a pH of about 3.0 to 5. The solution is then stirred for 1-2 hours, filtered and washed with distilled water and dried in an oven to form a powder. The exchange may be repeated, if necessary.

Following the ammonium ion exchange step, a copper ion exchange step is performed in which about 10 g of the ammonium-exchanged iron-containing CHA zeolite is added to a 0.25 M Cu(NO₃)₂ solution, followed by washing with distilled water and drying in an oven, followed by calcining at about 600° C. for shout 24 hours.

It should be appreciated that we have determined by XRF analysis that the amount of iron contained in the zeolite CHA catalyst remains the same before and after the incorporation of copper by ion-exchange. Accordingly, it can be concluded that no iron is being exchanged out when the copper ion exchange occurs. While not wishing to be bound by theory, it is believed that this is due to the fact that the iron is incorporated in the framework of the zeolite CHA, i.e., the crystal lattice structure of the zeolite CHA, rather than in cation exchange sites of the structure.

The resulting chabazite zeolite catalyst containing both iron and copper has a Si/Al ratio of about 10. The chabazite zeolite may be used in the form of self-supporting catalytic particles, but are preferably dispersed on a substrate. The substrate may comprise any suitable monolithic substrate such as cordierite. Alternatively, the substrate may comprise a wall-flow substrate such as a diesel particulate filter. Such a wall-flow filter substrate may also be formed from materials known in the art such as cordierite or silicon carbide or aluminum titanate.

The iron and copper containing CHA zeolite catalyst may be formed into a slurry and applied as a washcoat to the substrate by adding a binder such as titania, zirconia, or alumina. When applied as a washcoat onto a monolithic substrate, the catalyst composition is preferably deposited at a concentration of about 0.25 to about 3 g/in.³ The coated substrate is then preferably dried and calcined to provide an adherent coating. The catalyst may be applied in one or more layers to the substrate.

The iron and copper containing (CHA) zeolite catalyst may be used in the treatment of exhaust gas streams from gasoline or diesel engines as an SCR catalyst for the reduction of nitrogen oxides. The catalyst may be provided in conjunction with other gas treatment components such as oxidation catalysts, other SCR catalysts, or diesel particulate filters.

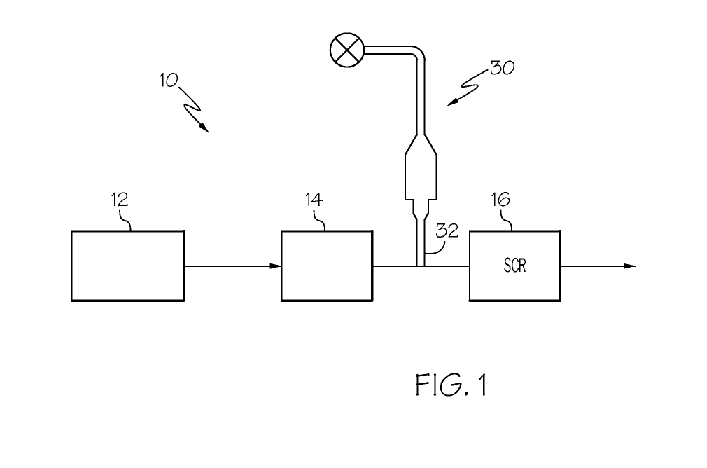

Referring now to FIG. 1, one embodiment of an exhaust treatment system 10 is shown which includes a (CHA) zeolite SCR catalyst 16 containing both iron and copper. As shown in FIG. 1, the exhaust treatment system is coupled to an exhaust manifold 12 of a vehicle engine and includes an oxidation catalyst 14. The SCR catalyst 16 is positioned downstream from the oxidation catalyst.

The treatment system may further include a reductant delivery system 30 which is coupled to the exhaust manifold upstream of the SCR catalyst 16. A reductant, such as ammonia, aqueous urea, or other ammonia-generating compound, is delivered to the reductant delivery system in metered amounts, typically in the form of a vaporized mixture of the reductant and water. The reductant delivery system further includes an injector 32 for injecting the reductant into the exhaust stream at the appropriate time.

In this treatment system, there is no need to include any additional SCR catalysts as the catalyst containing both iron and copper operates over a wide temperature range such that no additional SCR catalysts are necessary.

During operation, as exhaust gas generated by the engine passes through the exhaust gas manifold 12, it passes through the oxidation catalyst 14 such that unburned hydrocarbons and CO are oxidized to CO₂ and water vapor. The exhaust gas then flows through the iron and copper containing (CHA) zeolite SCR catalyst 16 such that NOₓ is removed from the gas stream by selective catalyst reduction with ammonia supplied from the reductant delivery system 30 to form nitrogen and water vapor.

The catalyst can achieve NOx conversion of at least about 75%, and more preferably, at least about 95% over temperatures ranging from about 200° C. to about 700° C.

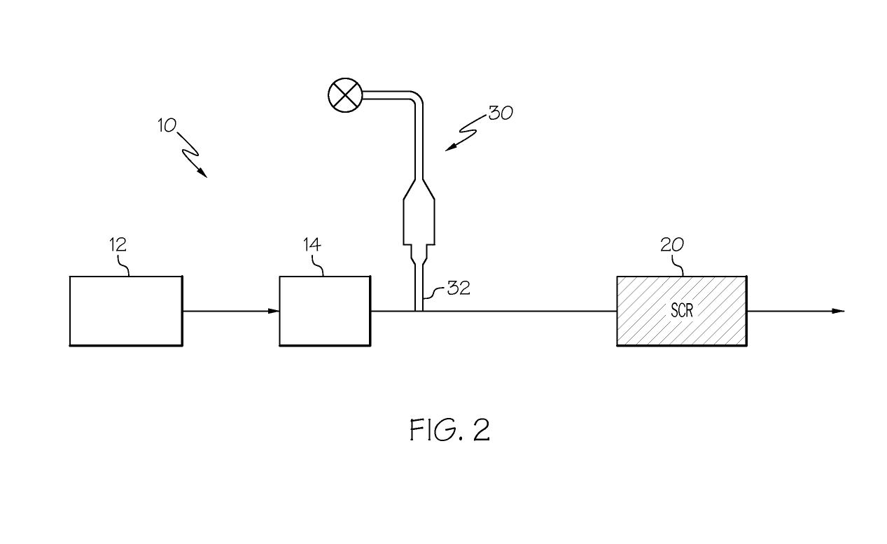

Referring to FIG. 2, where like reference numerals refer to like elements, another embodiment of an exhaust treatment system is shown in which the iron and copper containing (CHA) zeolite catalyst is coated as an SCR catalyst on a diesel particulate filter 20 used in diesel engines. The filter includes an inlet, an outlet, and at least one porous wall. By coated “on,” we mean that the catalyst 1) is coated on the filter such that it is position on the surface of the walls, inlet or outlet, 2) is coated on the porous walls such that it permeates the filter, i.e., it is positioned within the filter, or 3) is coated so that it is both within the porous filter walls and on the surface of the walls. In this embodiment, the SCR catalyst preferably has a loading of about 0.25 to about 3.0 g/in.³ The diesel particulate filter preferably has a porosity of about 38 to 80%, and more preferably, about 50 to 65%.

In the embodiment shown, during operation, unburned hydrocarbons and CO in the exhaust gas are converted at the oxidation catalyst 14 as described above. The exhaust gas then flows through the inlet of the filter 18 and passes through the porous walls of the filter 18 coated with the iron and copper containing zeolite (CHA) SCR catalyst such that NOₓ is reduced to nitrogen in the gas stream and, in addition, particulates contained in the exhaust gas are collected in the filter. By using the iron and copper containing zeolite (CHA) catalyst on the filter, the filter can maintain good activity at high temperatures, for example, at about 650° C. to 700° C. and additional NOₓ reduction can be achieved during regeneration of the filter when the soot/particulates are burned.

In order that the invention may be more readily understood, reference is made to the following examples which are intended to illustrate embodiments of the invention, but not limit the scope thereof.

### EXAMPLE 1

A chabazite zeolite containing iron and copper was prepared in accordance with an embodiment of the invention. The sample contained 1.06 wt % iron and 4.48 wt % copper. The silica/alumina ratio was 9.3.

A comparative commercially available CuCHA was also obtained. The iron and copper containing CHA zeolite (CuFeCHA) and conventional CuCHA were degreened for 4 hours at 750° C. Both samples were then tested using a simulated vehicle exhaust containing NOₓ. The samples were tested in a bench flow reactor employing a simulated diesel exhaust consisting of 14% O₂, 5% CO₂, 4.5% H₂O, 350 ppm NO, 350 ppm NH₃, and the balance N₂. The CuCHA sample was obtained as a washcoated monolith and was tested in the above gas stream at a flow velocity resulting in a space velocity of 30,000/hr. A 3.0 g sample of CuFeCHA was tested using a gas flow of 9.65 SLPM (standard liter per minute). This is equivalent to a space velocity of 30,000/hr over a washcoated monolith. All components except for N₂ and O₂ were analyzed simultaneously by FTIR.

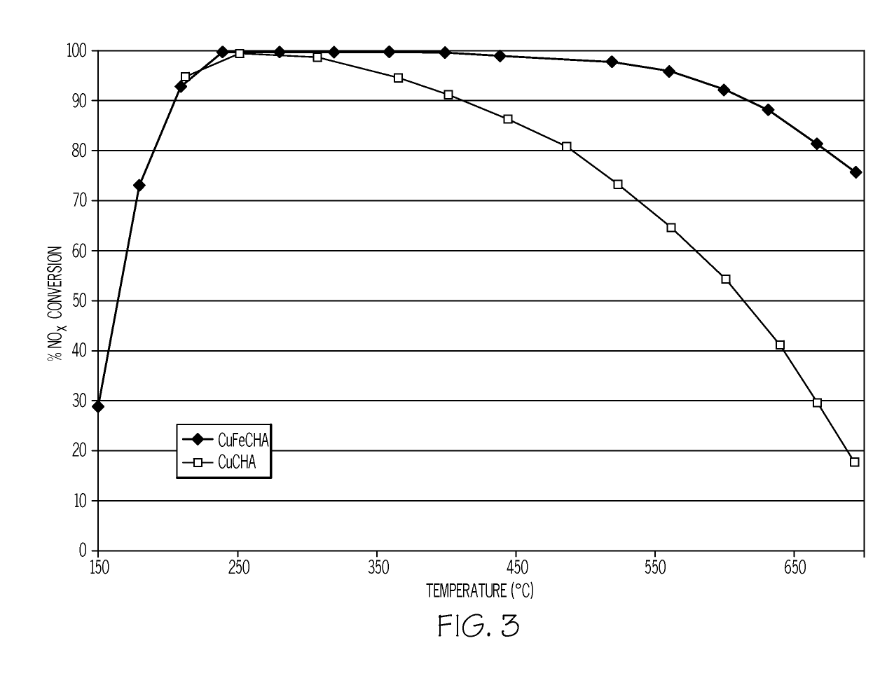

As can be seen from the graph in FIG. 3, the CuFeCHA catalyst provided more effective conversion of NOₓ over the entire range of tested temperatures (150° C. to about 675° C.), and NOₓ conversion exceeded 90% over a wide range of operating temperatures between about 200° C. to about 600° C.

### EXAMPLE 2

The catalyst samples from Example 1 were tested subjected to accelerated aging for 80 hours at 800° C. The samples were initially degreened for 4 hours at 750° C. in a gas flow containing 14% O₂, 5% CO₂, 4.6% H₂O and the balance N₂. The samples were subsequently aged in an identical gas stream for an additional 80 hours at 750° C. The samples were then tested using simulated vehicle exhaust as described in Example 1.

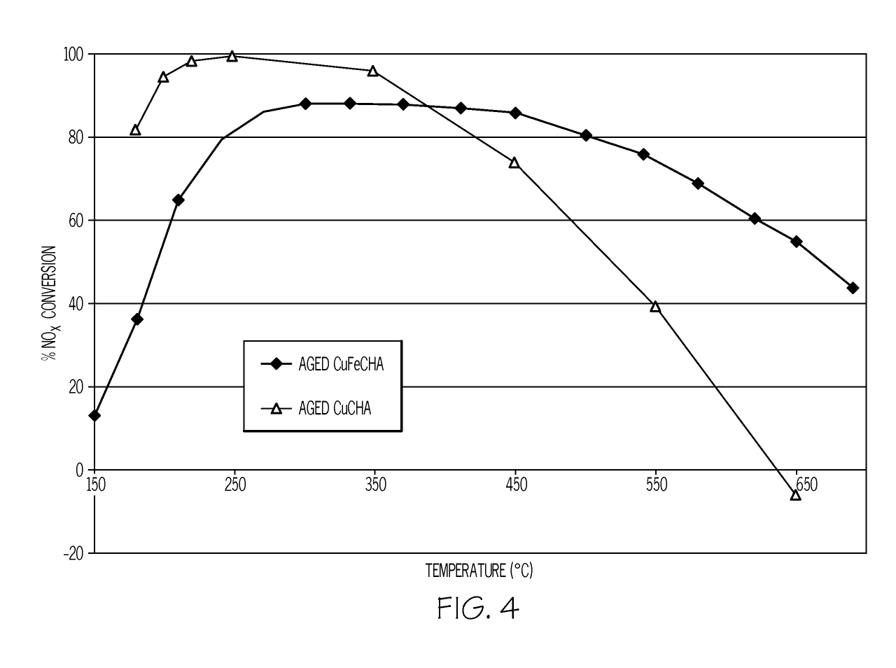

As can be seen from the graph in FIG. 4, the iron and copper containing chabazite zeolite sample exhibited superior NOₓ conversion to that of the copper chabazite catalyst over a wider temperature range.

Having described the invention in detail and by reference to preferred embodiments thereof, it will be apparent that modifications and variations are possible without departing from the scope of the invention.

What is claimed is:

1. A catalyst comprising:
a zeolite having a chabazite (CHA) structure which contains iron and copper; wherein said iron has been incorporated into said zeolite during synthesis of said zeolite with no post-synthesis step, and wherein said copper has been incorporated into said zeolite by ion-exchange after the synthesis of said zeolite.

2. The catalyst of claim 1 exhibiting NOₓ reduction activity at a temperature ranging from about 200° C. to about 700° C.

3. The catalyst of claim 1 washcoated onto a substrate selected from a cordierite monolith, a cordierite wall-flow filter, a silicon carbide wall-flow filter, or a metallic monolith substrate.

4. The catalyst of claim 1 wherein said iron is present in said chabazite zeolite in an amount of from about 0.25% to about 4.0% by weight.

5. The catalyst of claim 1 wherein said iron is present in said chabazite zeolite in an amount of from about 0.5% to about 1.25% by weight.

6. The catalyst of claim 1 wherein said copper is present in said chabazite zeolite in an amount of from about 2.5 to about 6.6% by weight.

7. The catalyst of claim 1 wherein said copper is present in said chabazite zeolite in an amount of from about 3% to about 5.5% by weight.

8. The catalyst of claim 1 wherein said chabazite structure comprises SSZ-13.

9. The catalyst of claim 1 wherein said zeolite has a pore size of about 3 to about 5 Angstroms.

10. The catalyst of claim 1 having a surface area of at least about 400 m²/g.

11. The catalyst of claim 1 wherein said zeolite has a silica-to alumina ratio of about 7 to about 15.

12. A method of making a chabazite zeolite catalyst containing iron and copper therein, said method comprising:
preparing an aqueous mixture containing a silica source and a strong base;
adding a NH₄—Y zeolite and a source of ferric ions to said mixture,
adding an organic templating agent to said mixture, and
heating and calcining said mixture to form a chabazite zeolite containing iron therein;
performing an ammonium-ion exchange of said zeolite; and
performing a copper-ion exchange to form said catalyst.

13. The method of claim 12 wherein said strong base comprises sodium hydroxide.

14. The method of claim 12 wherein said templating agent comprises N,N,N-trimethyl-1-adamantanamine iodide.

15. The method of claim 12 wherein said source of ferric ions is included in said mixture in an amount of about 5 to 100% by weight based on the weight of said NH₄—Y zeolite.

16. A catalyst produced by the method of claim 12.

17. A method for treating engine exhaust gases comprising:
providing an SCR catalyst in an exhaust passage of an engine, wherein said SCR catalyst comprises a chabazite zeolite catalyst containing iron and copper; wherein said iron has been incorporated into said zeolite during synthesis of said zeolite with no post-synthesis step, and wherein said copper has been incorporated into said zeolite by ion-exchange after synthesis of said chabazite; and
exposing said catalyst to engine exhaust gas emissions containing NOₓ such that at least a portion of said emissions are reduced to N₂ at a temperature between about 200° C. to about 700° C.

18. An exhaust treatment system comprising:
a diesel oxidation catalyst;
an SCR catalyst positioned downstream from said diesel oxidation catalyst, said SCR catalyst comprising a chabazite zeolite catalyst containing iron and copper.

19. The exhaust treatment system of claim 18 further including a diesel particulate filter positioned downstream from said SCR catalyst; wherein said filter includes a coating of said chabazite zeolite catalyst thereon.
